(19) United States
(12) Patent Application Publication
(10) Pub. No.: US 2019/0192261 A1
(43) Pub. Date: Jun. 27, 2019

(54) METHOD AND SYSTEM FOR NON-SURGICAL TREATMENT OF THE LOWER FACE AND LIPS; AND ORAL APPLIANCE THEREFORE

(71) Applicant: GELRO,LLC, White Plains, NY (US)

(72) Inventors: MICHAEL GELB, HARTSDALE, NY (US); THOMAS ROMO, III, NEW YORK, NY (US)

(73) Assignee: GELRO,LLC, White Plains, NY (US)

(21) Appl. No.: 16/324,996

(22) PCT Filed: Sep. 18, 2017
(86) PCT No.: PCT/US17/52056

§ 371 Date: Feb. 12, 2019

Related U.S. Application Data
(60) Provisional application No. 62/395,560, filed on Sep. 16, 2016.

(51) Int. Cl. A61C 7/08; A61C 7/36

(52) U.S. Cl. CPC A61C 7/08; A61C 7/36

(57) ABSTRACT

The present invention provides a method and apparatus for non-surgical treatment of the lower face and lips to achieve an aesthetic appearance and anatomical alignment of a patients jaw and associated skeletal features to achieve an orthognathic facial profile, with approved appearance and enabling future treatments without direct surgical impact. The invention relates to the oral apparatus being an appliance having a specified structure thereon.

### CROSS REFERENCE TO RELATED APPLICATIONS

This application relates to and claims priority from U.S. Prov. Ser. No. 62/395,560 filed Sep. 16, 2016, the entire contents of which are incorporated herein fully by reference.

### FIGURE SELECTED FOR PUBLICATION

FIG. 6A

### BACKGROUND OF THE INVENTION

### Field of the Invention

The present invention relates to a method and system for non-surgical treatment of the lower face and lips of a qualified patient. Additionally, the invention relates to an oral appliance with a specific geometry and structure. More particularly, the present invention provides a method and system for non-surgical treatment with an oral appliance of a patient suffering from a combination retrognathic facial type and dermal negatives such as wrinkles, thinning lips, or other cosmetic concerns.

### Description of the Related Art

Conventional application of cosmetic surgical techniques to treat facial appearance involve a number of surgical methods which involve extensive manipulation of skin and musculature of a patient, as well as extensive recovery time and substantial risk for both physician and patient. Exemplary conventional surgical techniques are generally illustrated in FIGS. 1 and 2.

In extensive and difficult conventional cosmetic treatments bones, cartilage, and other patient-originated-structures are grafted, broken and repositioned. Often extensive skeletal manipulation is required for even subtle corrective cosmetic appearance. Of course, this is additionally necessary on traumatic injury treatment for recovery of lost tissue through accident, war, or other injurious result.

Further, as noted in FIG. 3, various muscular-skeletal and tissue-based concerns can also arise due to the ageing process, which allows gravity to pull on tissue, muscle, and bone. This is also of concern in the lower facial region where wrinkles can occur in tissue, flattening of tissue and loss of a desirable appearance can occur.

Unfortunately, each of the conventional cosmetic treatments for alignment of structure and removal of skin lines involves substantive dangers to the patience and are not suitable for all patients. Additionally, such conventional treatments have an excessively high cost and require an excessive recovery time for each patient with associated post-treatment risks. Further, the conventionally known implantable devices (e.g., within the cheek bones, nasal cavity, etc.) have associated risks with long term inter-body use, breakdown, and infection. Accordingly, there is a need for an improved method and system for non-surgical cosmetic techniques to achieve a similar cosmetic result with elimination of the negative detriments common in cosmetic surgical techniques. Also accordingly there is a need for an apparatus having particular requirements to assist in minimizing the need for cosmetic surgery.

### ASPECTS AND SUMMARY OF THE INVENTION

In response, it is now recognized that there is a need for the present invention that provides a method and system for non-surgical treatment of the lower face and lips to achieve an aesthetic appearance and anatomical alignment of a patients jaw and associated skeletal features to achieve an orthognathic facial profile, with approved appearance and enabling future treatments without direct surgical impact.

According to another aspect of the present invention, there is provided an apparatus for non-surgical treatment of a patient having a retrognathic facial type and an upper jaw and lower jaw with respective upper teeth and lower teeth, the apparatus comprising: a bite plate appliance; the bite plate appliance having a two extending leg portions arranged at an acute angle relative to each other and joined by an arcuate curve; the bite plate appliance having a lower teeth contacting side with a continuous recess therealong for receiving the lower teeth during a use and an outer recess wall having a first thickness and an inner recess wall having a second thickness; the first thickness being less than the second thickness; the outer recess wall having an outermost recess wall surface and an outer recess wall tooth contacting surface; the inner recess wall having an innermost recess wall surface and an inner recess wall tooth contacting surface; a continuous recess peek extending between the outer recess wall and the inner recess wall along the arcuate curve; a tongue contacting side opposite the teeth contacting side and having an upper apex contour for contacting the upper jaw teeth during the use; the tongue contacting side including a concave step contour extending between the upper apex contour to a lower slope portion on the outermost recess wall surface of the outer recess wall; the upper apex contour being spaced between the innermost recess wall surface of the innermost recess wall and the continuous recess peek; and a distance between an upper apex of the upper apex contour and the lower slope portion being greater than the first thickness of the outer recess whereby an inter-engagement between the bite plate appliance and the upper teeth and the lower teeth urges the lower jaw forwardly relative to the upper teeth along the patient to achieve the orthognathic facial alignment during the use.

According to another aspect of the present invention there is provided an apparatus, wherein, the bite plate appliance further comprises: a plurality of tooth receiving contours in the lower teeth contacting side; the tooth receiving contours including opposing projections extending inwardly along the continuous recess relative to spaces between the lower jaw teeth, whereby the bite plate appliance securely engages the respective lower jaw teeth thereby enabling a secure the use.

According to another alternative aspect of the present invention, there is provided a method, for non-surgical treatment of a patient having a retrognathic facial type, comprising the steps of: conducting a first medical consultation with a surgical specialist to determine whether or not the patient is suitable for a use of a bite plate appliance and non-surgical remediation of facial defects and the surgical specialist determining that the patient is suitable for the use; conducting a first dental consultation with a dental specialist; the dental specialist determining that the patient is suitable for the use; conducting a step of manufacturing a bite plate appliance to achieve an orthognathic facial type and a TMJ (temporomandibular joint) alignment in the patient; the bite plate appliance having a two extending leg portions arranged at an acute angle relative to each other and joined by an arcuate curve; the bite plate appliance having a lower teeth contacting side with a continuous recess therealong for receiving said lower teeth during a use and an outer recess wall having a first thickness and an inner recess wall having a second thickness; said first thickness being less than said second thickness; said outer recess wall having an outermost recess wall surface and an outer recess wall tooth contacting surface; said inner recess wall having an innermost recess wall surface and an inner recess wall tooth contacting surface; a continuous recess peek extending between the outer recess wall and the inner recess wall along the arcuate curve; a tongue contacting side opposite the teeth contacting side and having an upper apex contour for contacting the upper jaw teeth during the use; the tongue contacting side including a concave step contour extending between the upper apex contour to a lower slope portion on the outermost recess wall surface of the outer recess wall; the upper apex contour being spaced between the innermost recess wall surface of the innermost recess wall and the continuous recess peek; and a distance between an upper apex of the upper apex contour and the lower slope portion being greater than the first thickness of the outer recess whereby an inter-engagement between the bite plate appliance and the upper teeth and the lower teeth urges the lower jaw forwardly relative to the upper teeth along the patient to achieve the orthognathic facial type alignment and a TMJ (temporomandibular joint) alignment during the use; conducting a second dental consultation and an installation of the appliance relative to the patient to achieve a the orthognathic facial type alignment and the TMJ alignment during the use; conducting a second medical consultation based upon an the bite plate appliance and conducting a first step of applying a hyaluronic acid based dermal filler to the patient; conducing a third medial consultation, following a previously defined first time period by the surgical specialist and determining whether or not to conduct a second step of applying the hyaluronic acid based dermal filler; and conducting a dental consultation, after a second time period, and providing an adjustment of the bite plate appliance whereby the patient achieves the non-surgical treatment.

The above and other aspects, features and advantages of the present invention will become apparent from the following description read in conjunction with the accompanying drawings, in which like reference numerals designate the same elements.

### BRIEF DESCRIPTION OF THE DRAWINGS

FIGS. 1 and 2 provide exemplary graphical illustration of known cosmetic practices involving surgical manipulation of the facial structure which are not suitable to achieve the goals of the proposed invention.

FIG. 3 provides an exemplary illustrative of the impacts of aging on the patient noting movement downwardly (inferior), and otherwise as noted.

FIG. 4 is a flow chart identifying the steps of the proposed method and procedure system for treatment using the proposed temporary apparatus having a specified contour.

FIG. 5A is an illustrative photograph of an initial facial photo for initial consultation (Step 1) noting a desirable Bolton Standard relative to a retrognathic facial type and FIG. 5B is an illustrative view of an exemplary retrognathic facial type (recessive chin).

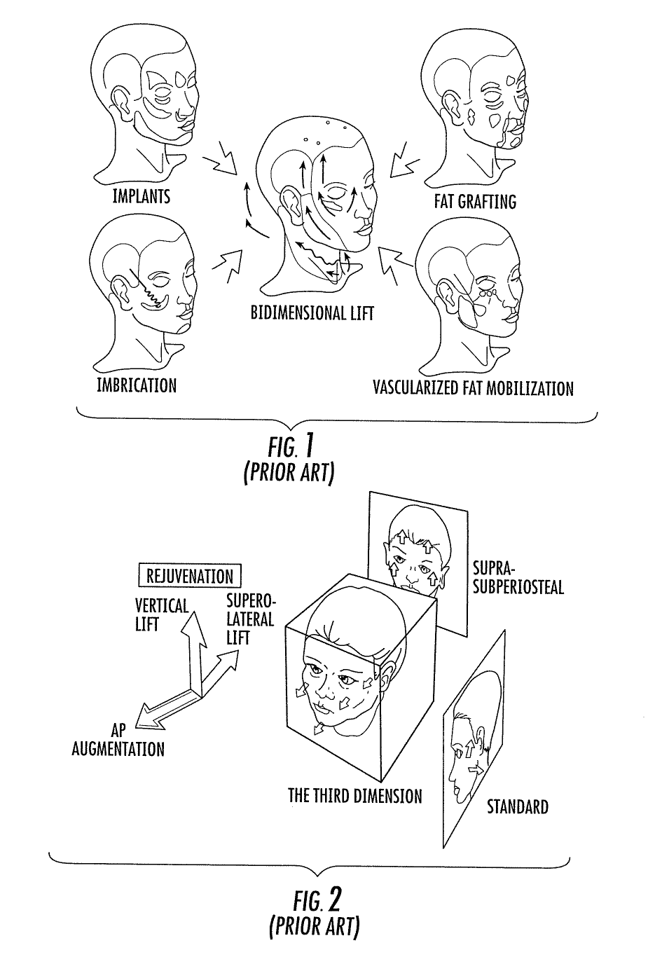

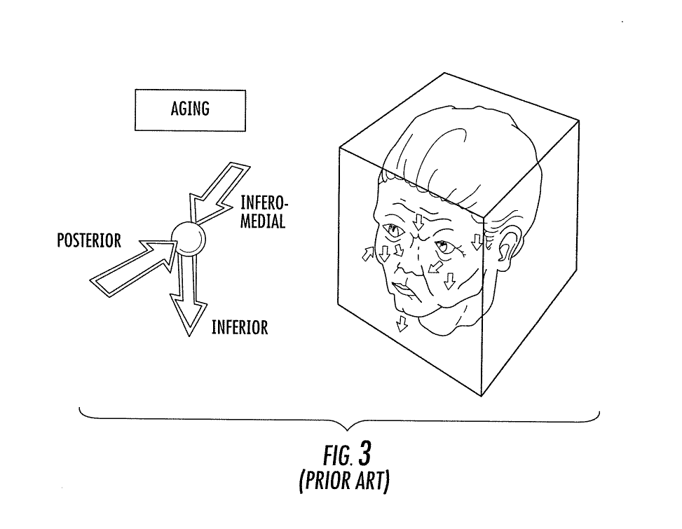

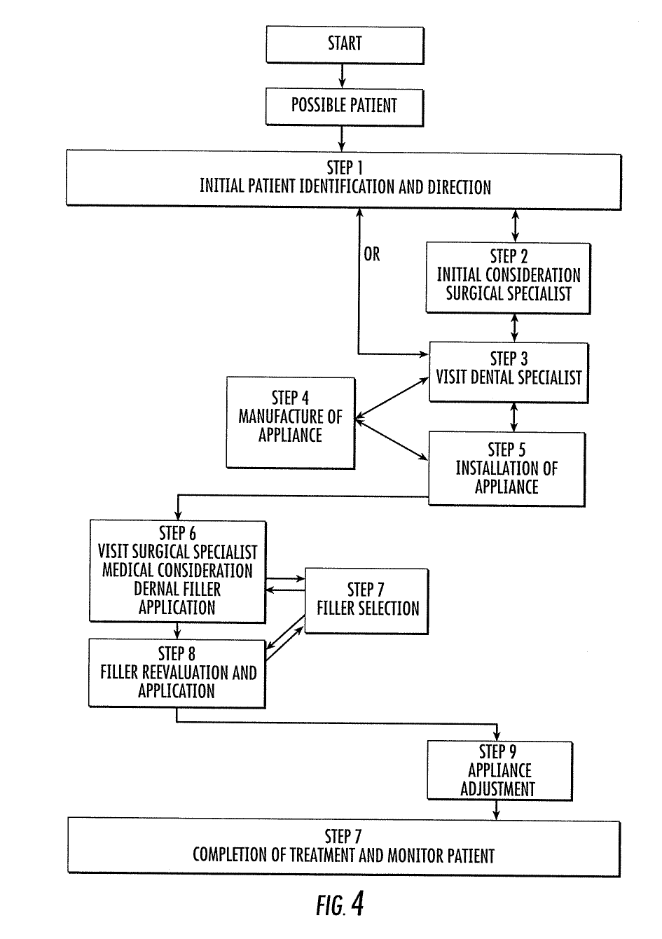

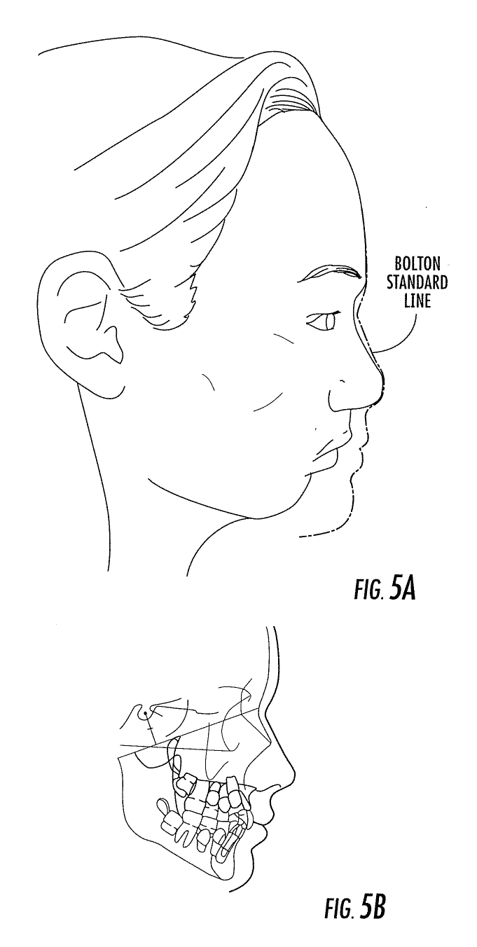

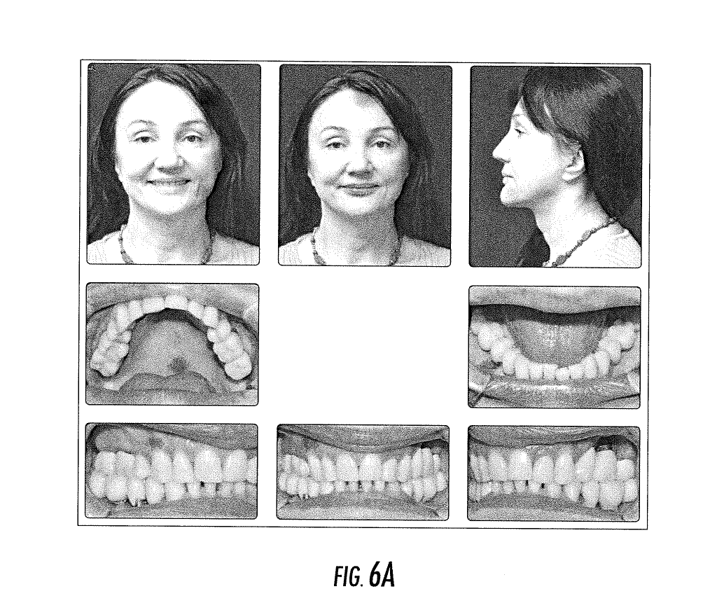

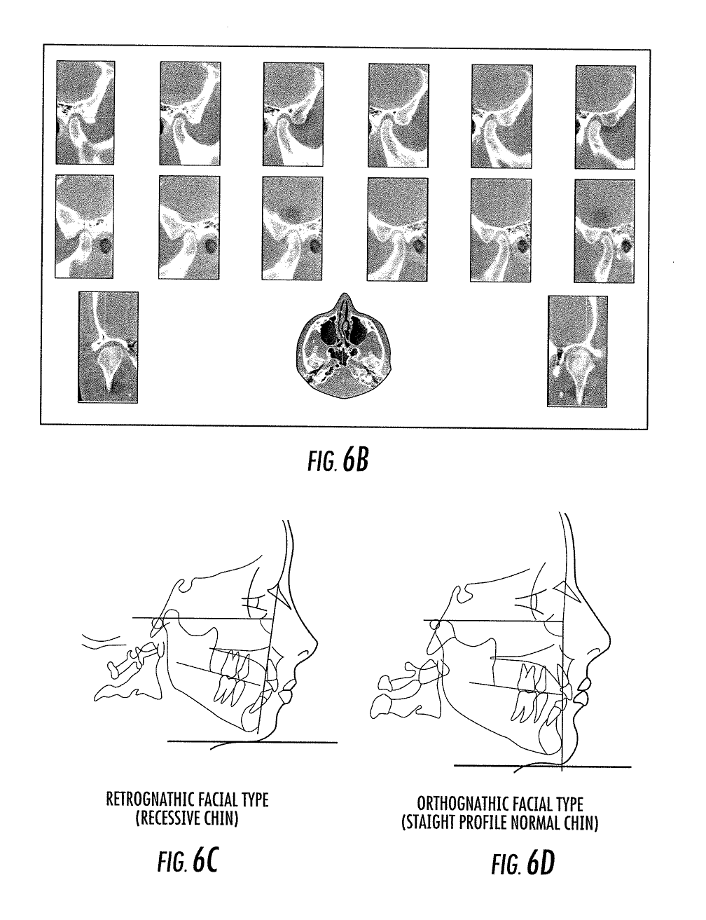

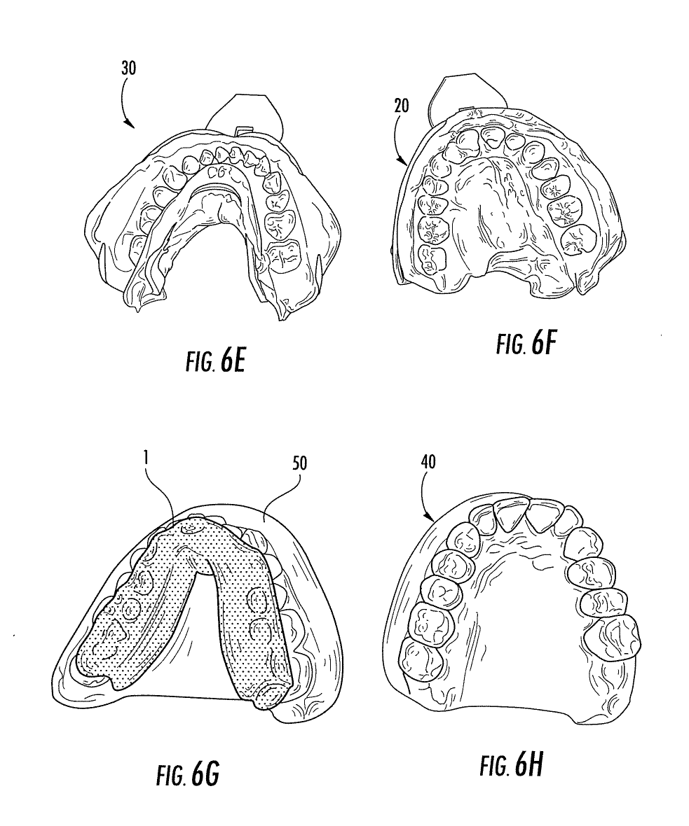

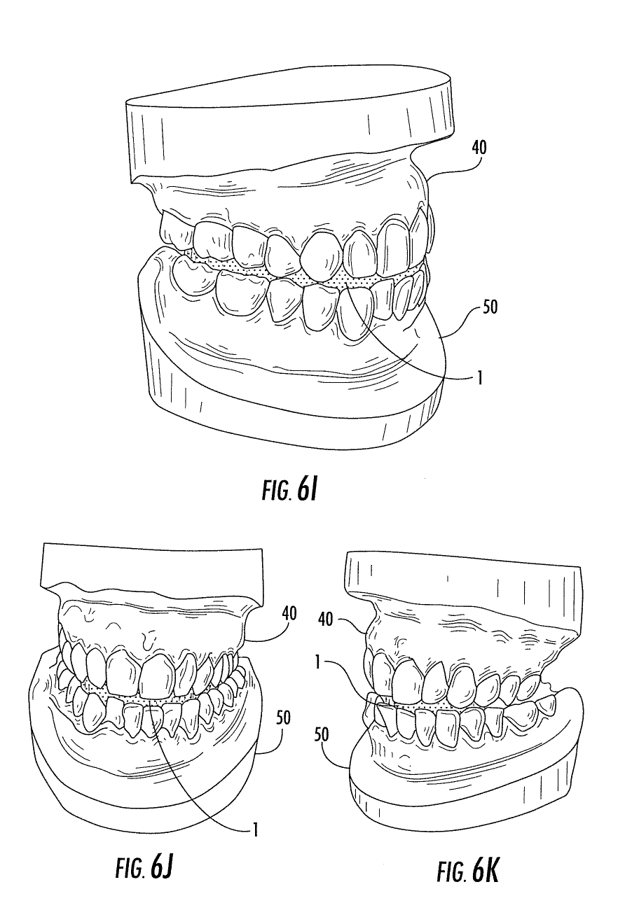

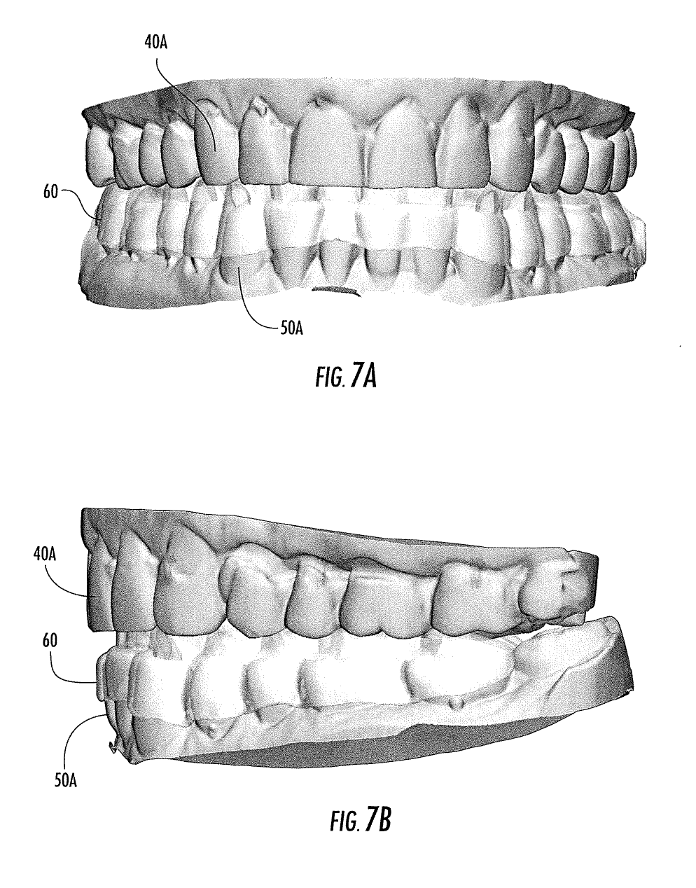

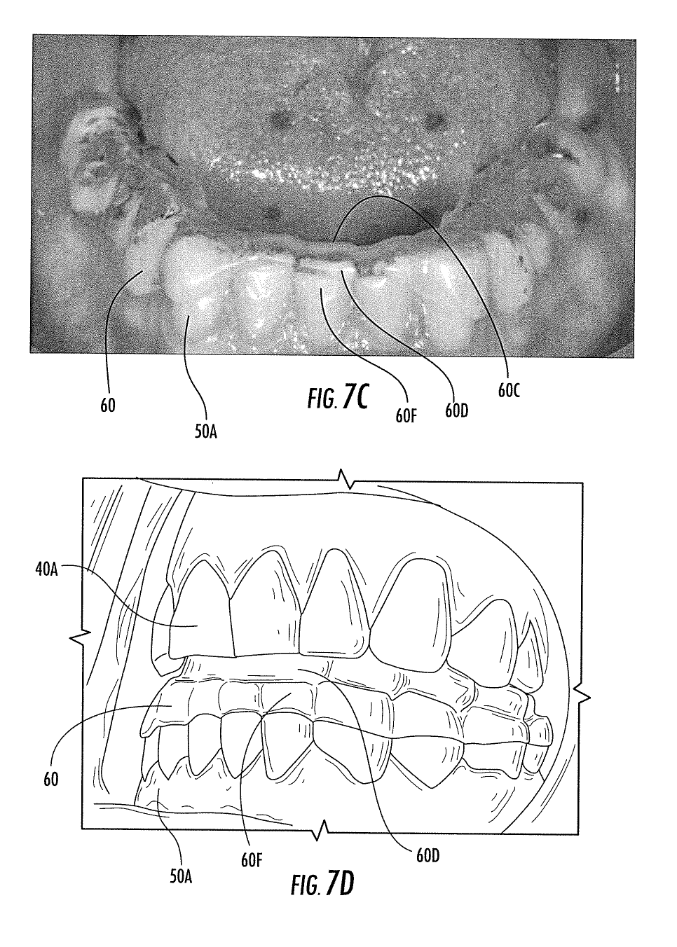

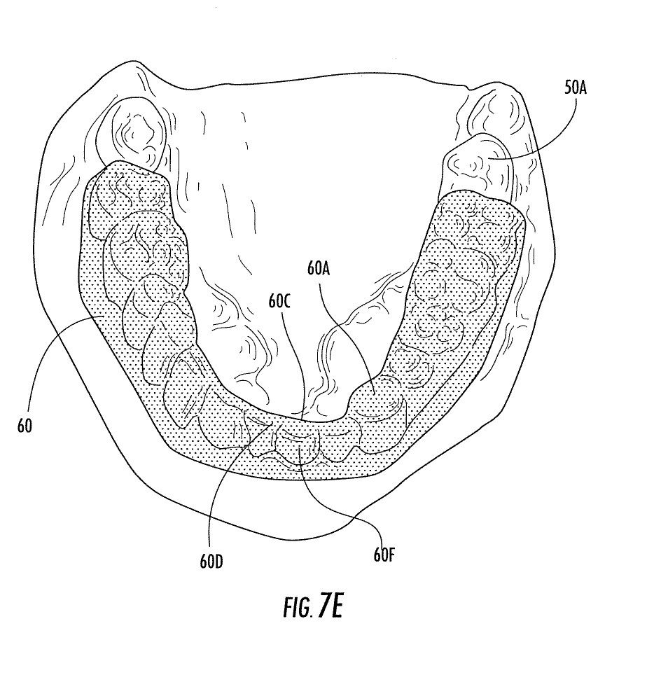

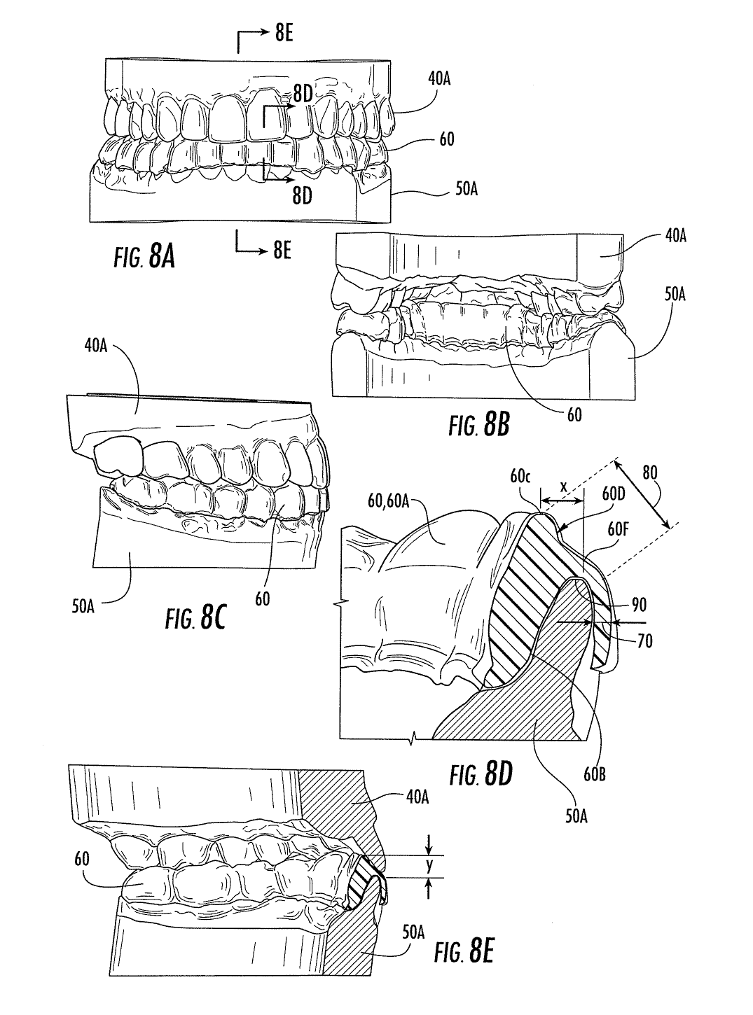

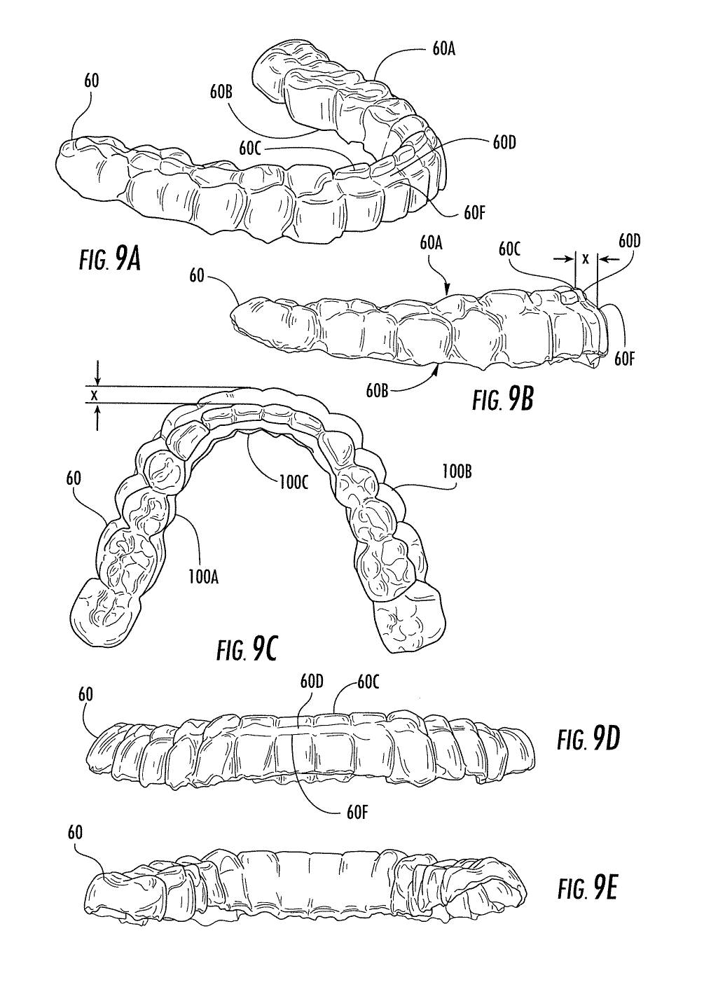

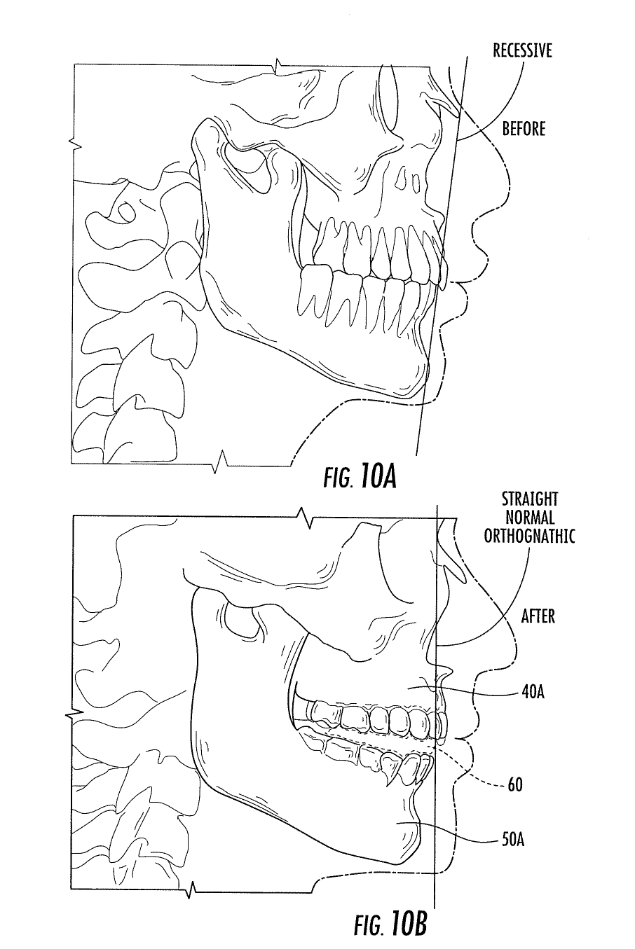

FIG. 6A depicts an exemplary facial analysis of a qualified patient. FIG. 6B is an exemplary imaging CBCT—Cone Beam Computed Tomography of a qualified patient showing a section of CBCT images; FIGS. 6C, 6D are an exemplary facial analysis of the qualified patient in a before-after analysis. FIGS. 6E, 6F depict a dental impression process (a combination of a moldable substance and a generic bite-mold backing plate are shown), and FIGS. 6G, 6H, and 6I, 6J, and 6K depict a final bite registration process confirmation for suitable alignment where the teeth alignment is achieved.

FIGS. 7A, 7B illustrate computer aided design (CAD) images of a corrective bite plate pre-construction illustration using a patient's own dental alignment and a calculated corrective alignment alignment and review and approval prior to the milling or other manufacture of a bite plate through any suitable method. FIGS. 7C (photo) and 7D (illustration) depict a manufactured bite plate apparatus in a patient's jaw and the resulting alignment. FIG. 7E illustrates the testing and fit confirmation of a bite plate based upon a patient's actual dental molding prior to insertion by a dental specialist.

FIGS. 8A to 8F depict an illustrative bite plate 60 within a patient's upper tooth set 40A and lower tooth set 50A. FIG. 8A is a front view with the bite plate installed. FIG. 8B is an interior view of the bite plate installed noting a smooth inner contour that meets upper and lower teeth. FIG. 8C is a side view of FIG. 8A rotated to the side. FIG. 8F is a cross-section of FIG. 8C depicting bite plate installed and relative tooth-contact alignments with a concave step portion. FIG. 8D is a close up of the cross section in FIG. 8F noting the lower tooth overlap and smooth receiving therein, as well as the upper apex for upper-tooth contact and the concave step portion in the apparatus above the lower slope portion.

Referring now to FIGS. 9A through 9E illustrate an appliance having an upper apex, concave step portion and a lower slope portion wherein the upper apex is forward of a tooth receiving portion.

Referring now to FIGS. 10A and 10B depict a pre-to-post appliance confirmation imagery depicting bone alignment based upon appliance use.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.

FIG. 4 provides a flow-chart illustration of one aspect of the proposed system and method for treating patients in need of aesthetic improvement of the appearance of the lower facial area in a manner not possible with plastic surgery alone. The use of a specified appliance having a desired geometry is provided therein.

FIG. 4 displays the flow chart of the proposed method of treatment comprising a beginning or start and designation of a possible patient into an initial Step 1 of identification of an initial patient in need who has visited either a dental specialist or a medical/surgical specialist and who has a retrognathic facial type (recessive chin). Step 1 involves the direction of the patient to a surgical specialist (Step 2) (e.g., a plastic surgeon) who will conduct an initial consideration (FIGS. 5A and 5B) and determination, using a Bolton Assessment and other techniques of a patient is a viable candidate for the proposed method and procedures and apparatus. The initial consultation would include conduction of a facial analysis, the selection of facial photos in a qualified studio, a brief dental analysis and an initial explanation of the proposed invention to the qualified patient.

In a subsequent Step 3, or where suitable an alternative Step 3, the qualified patient visits a dental specialist who conducts a facial photo baseline assessment (See FIG. 6A), a CBCT—Cone Beam Computed Tomography to determine the internal soft and hard tissues of the qualified patient (See FIG. 6B), and a comprehensive dental facial analysis is conducted (See FIGS. 6C and 6D) to confirm that a patient has a retrognathic facial type (recessive chin) and may be treated using the inventive method and system and apparatus to achieve an orthognathic facial type (straight profile, normal chin); dental impressions are taken (FIGS. 6H, 6E, 6F), with a necessary corrective calculation element 1 (see FIG. 6G, a bite registration process is conducted (FIGS. 6I, 6J, and 6K) that results in a suitable alignment of the facial structure as will be discussed.

As will be noted, FIG. 6E depicts a lower impression tray 30, FIG. 6F depicts an upper impression tray 20, the resultant patient top or upper teeth mold 40 is shown in FIG. 6H, and the resultant patient bottom or lower teeth mold 50 is shown in “FIG. 6G. Based upon the CBCT results, and facial analysis an idealized corrective calculation element 1 is constructed (See FIG. 6G) which allows both the top and lower molds 40, 50 to be aligned as shown when arranged in FIGS. 6I, 6K, and 6J. It will be understood that the phrases top/upper and lower/bottom refer to a patients ‘top’ teeth and those in their ‘lower’ jaw as will be within the scope and spirit of the present invention.

Therefore, it will be understood, that based upon the desired corrective calculation element structure (determined above), here in a Step 4 a corrective 60 bite plate is manufactured for correction of the misalignment of the facial structure to reach an orthognatic facial type (e.g., FIG. 6D). Illustrations of such imaged pre-manufacturing bite plates (in CAD form) with gradation differentiations and produced appliances are noted in FIGS. 7A, 7B. It is noted that the manufacturing of the bite plates may be by any recognized method suitable for the intended purpose.

It is noted that as a result of the procedure a patient will be able to speak normally, drink normally, consume semi-soft foods normally, and with practice or appliance securement to consume hard foods normally.

It is noted that in the determination of the selection of measurement for treatment according to the present invention, particular attention is paid to confirming an airway centric, bite-alignment, and a proper “4/7” technique as know by the provider of co-inventor (Michael Gelb, DDS, www.gelbcenter.com) and for TMJ (temporomandibular joint dysfunction) alignment.

As will be understood a lower illustrated or actual patient tooth line 50A is opposite an upper illustrated or actual patient tooth line 40A represented in FIGS. 7A-7E, as will be discussed. It will be further understood that a patient's idealized jaw alignment is not achieved through surgery, but instead through the use of bite plate appliance 60. It will be understood that appliance 60 has a top contact surface 60A and a lower contact surface 60B.

Referring additionally now to FIGS. 8A-8D and FIGS. 9A through 9E, bite plate 60 having a top surface 60A and a bottom surface 60B follows the general tooth line of the patient. Each appliance 60 additionally includes an upper front apex 60C, a lower slope apex 60F creating a concave step portion 60D which is in all cases positioned interior to a patient's outermost front teeth on lower teeth 50A (see cross-section in FIGS. 8E and 8F). Additionally, as noted each appliance bite plate 60 provides for the concave step portion 60D to be between lower step portion 60F covering the bottom teeth and upper apex 60C which meets the interior surface of the upper front teeth in 40A. As a result, during use, a patient's outermost front teeth on their upper teeth 40A (see FIG. 8F) always are received forward of upper apex 60C, along and in concave step portion 60D, thereby thrusting forwardly and outwardly lower teeth 50A and achieving a patients alignment in an orthognathic facial type without surgical techniques.

Referring now further to FIGS. 9A through 9E wherein an exemplary apparatus bite plate 60 is provided having an upper apex 60C that is recessed from lower slope portion 60F having a defined concave step portion 60D therebetween. As will be additionally appreciated, in combination with FIGS. 8D and 8F, concave step portion 60D is a distance X recessed from the lower slope portion 60F. It will be still further recognized that lower slope portion 60F always covers the front lower teeth portion 50A and an apex 90 (FIG. 8D) of the lower teeth in the cavity (shown), and as a result it is provided that upper apex 60C is always a positive distance, above the peak of lower front teeth, designated as a distance Y (FIG. 8F) in the front portion of appliance 60.

Referring again back to FIG. 4, in a Step 5, the constructed appliance 60 is received by the dental specialist for insertion of the appliance and suitable fitting and confirmation of achievement of the alignment objectives of the proposed treatment. Referring further to FIGS. 10A, 10B, a further radiographic review is provided as in FIGS. 6A through 8D to achieve the orthognathic facial type. As noted in FIG. 10B the lower jaws are separated by appliance 60 (shown in outline) which is transparent to the radiographic analysis (shown in shadow form). As a result the Step 5 radiographic analysis is and remains based upon the bone structure of a patient achieving a straight alignment based on movement of the lower jaw 50A relative to the upper jaw 40A using appliance 60 with the structures as discussed herein. As will be further understood, an outer thickness 70 of the outer front-portion of lower bite plate 60 which is less than a distance 80 measured between upper apex 60C and based of lower slop portion 60F (See FIG. 8D). Bite plate 60 is formed with two generally linear leg portions 100A, 100B arranged at an acute angle relative to each other and joined by an arcate curve 100C.

In a Step 6, in FIG. 4, the patient visits a medical specialist, in the form of a qualified plastic surgeon, to confirm initial considerations in prior Steps, and who further applies injectable hyaluronic-acid-based dermal fillers (or other suitable based fillers) following suitable medical protocols to achieve a desired cosmetic result for the exterior skin-surface of the patient; including removal of facial wrinkles, lining and for improving a plump appearance to lips, or for treatment of injury sites and other scarring. Non-limiting examples of hyaluronic acid based dermal fillers are those sold under the brand names Voluma® and Juvederm® (both products of Allergan, www.juvaderm.com). There is no restriction on the particular type of injectable dermal filler. The type of injectable dermal filler is selected by the surgical specialist in a Step 7 for suitable treatment of the designated patient. Continuing in Step 6, the surgical specialist compares the initial consideration steps in Steps 2 and 3, and otherwise, with the initial dermal filler application step in Step 6 until a desired result is reached.

In a Step 8 a further evaluation step is conducted with the surgical specialist to review the patient's facial result of the injectable dermal filler application in prior Step 6, and to make any suitable additional filler injections in compensation or for further surgical reasons.

In an alternative Step 9, following Step 8, the patient returns to the dental specialist for confirmation of the results of the appliance use, alignment and suitability for the patient following treatment steps 6-8. If necessary, adjustments are made to the appliance, or a further replacement appliance is create, for further enhancement to achieve not only the desired orthognathic alignment but also a preferred airway centered alignment of the patients airway, jaw, tongue, and structural alignments to achieve the optimal result for the patient.

As a result of the proposed invention, a patient has achieved a substantially non-surgical treatment of the appearance of the lower face and lips using the skills of a surgical specialist (plastic surgeon) and a dental specialist (qualified dentist), employing a custom milled anatomic bite plate used in conjunction with the co-inventors techniques and FDA approved hyaluronic acid based dermal fillers for an improved cosmetic appearance for each individual patient.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

1. An apparatus, for non-surgical treatment of a patient having a retrognathic facial type, an upper jaw and lower jaw with respective upper teeth and lower teeth, said apparatus comprising:
a bite plate appliance;
said bite plate appliance having a two extending leg portions arranged at an acute angle relative to each other and joined by an arcuate curve;
said bite plate appliance having a lower teeth contacting side with a continuous recess therealong for receiving said lower teeth during a use and an outer recess wall having a first thickness and an inner recess wall having a second thickness;
said first thickness being less than said second thickness;
said outer recess wall having an outermost recess wall surface and an outer recess wall tooth contacting surface;
said inner recess wall having an innermost recess wall surface and an inner recess wall tooth contacting surface;
a continuous recess peek extending between said outer recess wall and said inner recess wall along said arcuate curve;
a tongue contacting side opposite said teeth contacting side and having an upper apex contour for contacting said upper jaw teeth during said use;
said tongue contacting side including a concave step contour extending between said upper apex contour to a lower slope portion on said outermost recess wall surface of said outer recess wall;
said upper apex contour being spaced between said innermost recess wall surface of said innermost recess wall and said continuous recess peek; and
a distance between an upper apex of said upper apex contour and said lower slope portion being greater than said first thickness of said outer recess whereby an inter-engagement between said bite plate appliance and said upper teeth and said lower teeth urges said lower jaw forwardly relative to said upper teeth along said patient to achieve said orthognathic facial type alignment and a TMJ (temporomandibular joint) alignment during said use.

2. The apparatus, according to claim 1, wherein:
said bite plate appliance further comprises:
a plurality of tooth receiving contours in said lower teeth contacting side;
said tooth receiving contours including opposing projections extending inwardly along said continuous recess relative to spaces between said lower jaw teeth, whereby said bite plate appliance securely engages said respective lower jaw teeth thereby enabling a secure said use.

3. A method, for non-surgical treatment of a patient having a retrognathic facial type, comprising the steps of:
conducting a first medical consultation with a surgical specialist to determine whether or not said patient is suitable for a use of a bite plate appliance and non-surgical remediation of facial defects and said surgical specialist determining that said patient is suitable for said use;
conducting a first dental consultation with a dental specialist;
said dental specialist determining that said patient is suitable for said use;
conducting a step of manufacturing a bite plate appliance to achieve an orthognathic facial type and a TMJ (temporomandibular joint) alignment in said patient;
said bite plate appliance having a two extending leg portions arranged at an acute angle relative to each other and joined by an arcuate curve;
said bite plate appliance having a lower teeth contacting side with a continuous recess therealong for receiving said lower teeth during a use and an outer recess wall having a first thickness and an inner recess wall having a second thickness;
said first thickness being less than said second thickness;
said outer recess wall having an outermost recess wall surface and an outer recess wall tooth contacting surface;
said inner recess wall having an innermost recess wall surface and an inner recess wall tooth contacting surface;
a continuous recess peek extending between said outer recess wall and said inner recess wall along said arcuate curve;
a tongue contacting side opposite said teeth contacting side and having an upper apex contour for contacting said upper jaw teeth during said use;
said tongue contacting side including a concave step contour extending between said upper apex contour to a lower slope portion on said outermost recess wall surface of said outer recess wall;
said upper apex contour being spaced between said innermost recess wall surface of said innermost recess wall and said continuous recess peek; and
a distance between an upper apex of said upper apex contour and said lower slope portion being greater than said first thickness of said outer recess whereby an inter-engagement between said bite plate appliance and said upper teeth and said lower teeth urges said lower jaw forwardly relative to said upper teeth along said patient to achieve said orthognathic facial type alignment and a TMJ (temporomandibular joint) alignment during said use;
conducting a second dental consultation and an installation of said appliance relative to said patient to achieve a said orthognathic facial type alignment and said TMJ alignment during said use;
conducting a second medical consultation based upon an said bite plate appliance and conducting a first step of applying a hyaluronic acid based dermal filler to said patient;
conducing a third medial consultation, following a previously defined first time period by said surgical specialist and determining whether or not to conduct a second step of applying said hyaluronic acid based dermal filler; and
conducting a dental consultation, after a second time period, and providing an adjustment of said bite plate appliance whereby said patient achieves said non-surgical treatment.
